(19) United States
(12) Patent Application Publication
(10) Pub. No.: US 2017/0168009 A1
(43) Pub. Date: Jun. 15, 2017

(54) GAS SENSOR AND MANUFACTURING METHOD THEREOF

(71) Applicant: TAIWAN CARBON NANO TECHNOLOGY CORPORATION, MIAOLI COUNTY (TW)

(72) Inventors: Yu-Hsuan Liao, MIAOLI COUNTY (TW); Chia-Hung Li, MIAOLI COUNTY (TW); Chun-Hsien Tsai, MIAOLI COUNTY (TW); Ting-Chuan Lee, MIAOLI COUNTY (TW); Chun-Jung Tsai, MIAOLI COUNTY (TW)

(21) Appl. No.: 15/096,835

(22) Filed: Apr. 12, 2016

(30) Foreign Application Priority Data
Dec. 11, 2015 (TW) 104141667

(51) Int. Cl. G01N 27/417; G01N 27/407

(52) U.S. Cl. CPC G01N 27/417; G01N 27/4071; G01N 27/4077; G01N 27/4075; G01N 27/4073

(57) ABSTRACT

A gas sensor includes a substrate, a heating layer, an insulation layer and a plurality of arranged detection units. The heating layer is on the substrate. The insulation layer is on the heating layer. The detection units are on the insulation layer, and each detection unit includes a detecting electrode, a separating portion and a reaction sensing film. The separating portion includes a plurality of separating walls extending upwards. The separating walls surround to form an accommodating space. The reaction sensing film is in the accommodating space in the separating portion and in contact with the detecting electrode. An electrochemical reaction is produced when the reaction sensing film comes into contact with a gas under test to cause the detecting electrode to generate a recognition signal corresponding to the gas under test.

### FIELD OF THE INVENTION

The present invention relates to a gas sensor, and particularly to a gas sensor having low manufacturing costs and a simple manufacturing process.

### BACKGROUND OF THE INVENTION

A gas sensor commonly refers to a device for detecting physical or chemical properties of a gas, and is extensively applied in fields of medicine, industry, technology and environment protection.

For example, the U.S. Pat. No. 9,125,590 B2 discloses a medical ventilator capable of early detecting and recognizing types of pneumonia. The above disclosure includes an aspiration pipeline and a gas recognizing device. The gas recognizing device uses a gas recognition chip to analyze a gas aspired by a patient from the aspiration pipeline to identify the type of pneumonia. The gas recognition chip includes a sensor array, a sensor interface circuit, a stochastic neural network chip, a memory and a microcontroller. The microcontroller is connected to the sensor interface circuit, the stochastic neural network chip and the memory to control operations of these circuits. Thus, the type of pneumonia can be early detected and identified to provide more effective treatments.

However, in the above known technology, the manufacturing of the sensor array is implemented by a semiconductor fabrication process. In general, such type of sensor array has a complicated structure and production costs of the semiconductor fabrication process are high, hence disfavoring commercial promotion of such sensor array.

### SUMMARY OF THE INVENTION

The primary object of the present invention is to solve issues of a complicated structure of a sensor array of a conventional gas sensor as well as large amounts of manufacturing time and high production costs of a semiconductor fabrication process of the sensor array.

To achieve the above object, the present invention provides a gas sensor. The gas sensor includes: a substrate; a heating layer on the substrate; an insulation layer on the heating layer; and a plurality of detection units on the insulation layer, each of the detection units including a detecting electrode, a separating portion surrounding the detecting electrode, and a reaction sensing film. The detecting electrode includes a first electrode and a second electrode. The first electrode includes a first strip-like electrode, and a first finger-like electrode extending from the first strip-like electrode. The second electrode includes a second strip-like electrode, and a second finger-like electrode extended from the second strip-like electrode. The first finger-like electrode and the second finger-like electrode are alternately arranged. The reaction sensing film is in an accommodating space in the separating portion and in contact with the detecting electrode. The reaction sensing film comes into contact with a gas under test to produce an electrochemical reaction to cause the detecting electrode to generate a recognition signal corresponding to the gas under test.

To achieve the above object, the present invention provides a manufacturing method of a gas sensor. The manufacturing method includes steps of: providing a substrate; forming a heating layer on the substrate; forming an insulation layer on the heating layer; forming at least one detecting electrode on the insulation layer, the detecting electrode including a first electrode and a second electrode, the first electrode including a first strip-like electrode and a first finger-like electrode extending from the first strip-like electrode, the second electrode including a second strip-like electrode and a second finger-like electrode extending from the second strip-like electrode, the first finger-like electrode and the second finger-like electrode alternately arranged; forming a separating portion on the insulation layer, the separating portion surrounding the detecting electrode, and forming an accommodating space on the detecting electrode; and filling a macromolecular material into the accommodating space in the separating portion, and forming a reaction sensing film to obtain the gas sensor.

It is known from the above that, compared to the prior art, the present invention achieves following effects. The gas sensor of the present invention has a simple structure and a convenient fabrication process without involving a semiconductor apparatus or fabrication process, and is suitable for mass production at lower costs.

### BRIEF DESCRIPTION OF THE DRAWINGS

FIG. 1 is a top view of a gas sensor according to an embodiment of the present invention;

FIG. 2 is a section view of FIG. 1 along A-A;

FIG. 3 is a schematic diagram of a detecting electrode according to an embodiment of the present invention; and

FIG. 4A to FIG. 4D are schematic diagrams of a process of a manufacturing method according to an embodiment of the present invention.

### DETAILED DESCRIPTION OF THE PREFERRED EMBODIMENTS

Details and technical contents of the present invention are given with the accompanying drawings below.

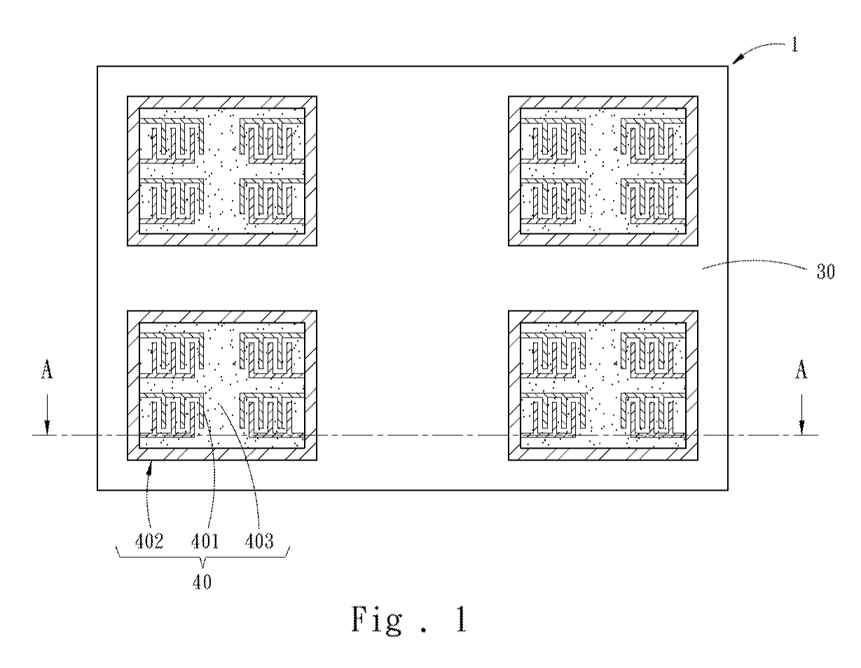

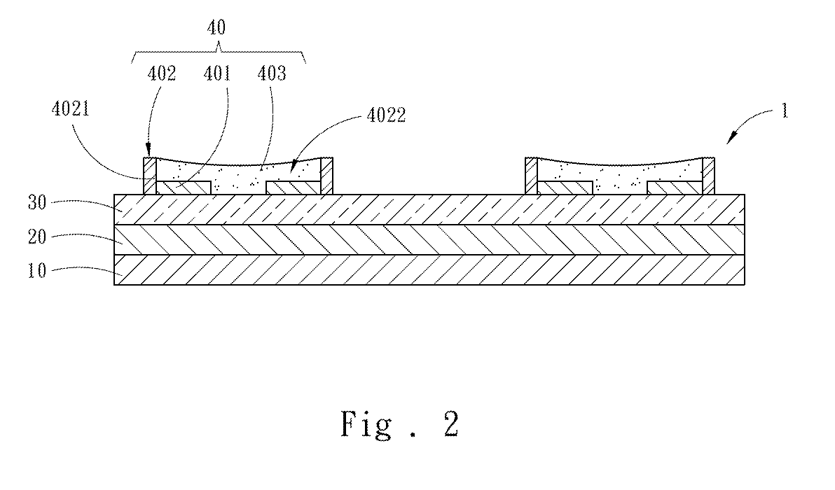

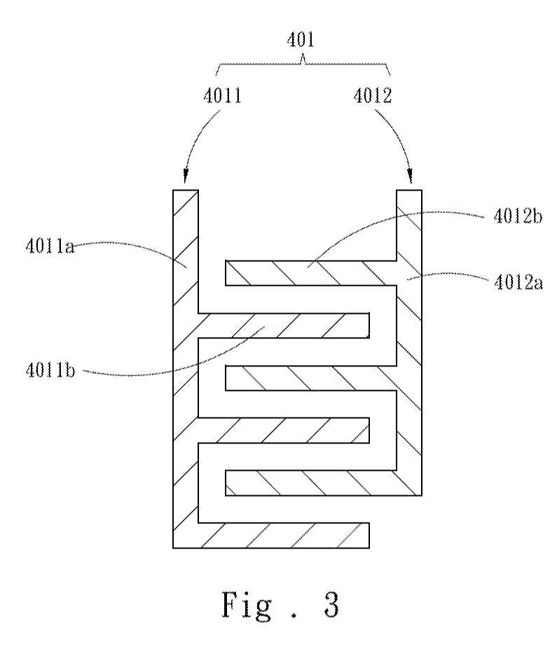

FIG. 1, FIG. 2 and FIG. 3 show a top view of a gas sensor, a section view along A-A in FIG. 1, and a schematic diagram of a detecting electrode according to an embodiment of the present invention, respectively. A gas sensor 1 of the present invention includes a substrate 10, a heating layer 20, an insulation layer 30 and a plurality of arranged detection units 40. The heating layer 20 is on the substrate 10. For example, the substrate 10 may be made of a material selected from the group consisting of glass, indium tin oxide (ITO) and polyethylene terephthalate (PET). The heating layer 20 is made of a material that can be heated to a temperature higher than room temperature. In one embodiment of the present invention, the heating layer 20 may be made of ITO, and preferably receives a current and is heated to a temperature between 30° C. and 70° C. The insulation layer 30 is on the heating layer 20, and may be made of PET.

The detection units 40 are on the insulation layer, and are arranged in an array or a pattern. In the embodiment, the detection units 40 may be arranged in an 8×4 array, and are preferably spaced by 100 μm from one another. Each of the detection units 40 includes at least one detecting electrode 401, a separating portion 402 and a reaction sensing film 403. In the present invention, the reaction sensing film 403 may be made of at least one material selected from the group consisting of carboxymethyl cellulose ammonium salt (CMC—NH₄), polystyreine (PS), poly(ethylene adipate), poly(ethylene oxide) (PEO), polycaprolactone, poly(ethylene glycol) (PEG), poly(vinylbenzyl chloride) (PVBC), poly(methylvinyl ether-alt-maleic acid), poly(4-vinylphenol-co-methyl methacrylate), ethyl cellulose (EC), poly(vinylidene chloride-co-acrylonitrile) (PVdcAN), polyepichlorohydrin (PECH), polyethyleneimine, beta-amyloid(1-40), human galectin-1 or human albumin, styrene/allyl alcohol (SAA) copolymer, poly(ethylene-co-vinyl acetate), polyisobutylene (PIB), poly(acrylonitrile-co-butadiene), poly(4-vinylpyridine), hydroxypropyl methyl cellulose, polyisoprene, poly(alpha-methylstyrene), poly(epichlorohydrin-co-ethylene oxide), poly(vinyl butyral-co-vinyl alcohol-vinyl acetate), polystyrene (PS), lignin, acylpeptide, poly(vinyl proplonate), poly(vinyl pyrrolidone) (PVP), poly(dimer acid-co-alkyl polyamine), poly(4-vinylphenol), poly(2-hydroxyethyl methacrylate), poly(vinyl chloride-co-vinyl acetate), cellulose triacetate, poly(viny stearate), poly(bisphenol A carbonate) (PC), poly(vinylidene fluoride (PVDF). In the embodiment, the number of the detecting electrodes 401 in each of the detection units 40 may be four, and the detecting electrodes 401 are preferably spaced by 30 μm from one another. As such, the number of the detecting electrodes 401 may be 128. However, the number of the detecting electrodes 401 may be modified according to different application requirements, and is not limited to the example in this embodiment.

Each of the detecting electrodes 401 includes a first electrode 4011 and a second electrode 4012. The first electrode 4011 includes a first strip-like electrode 4011a and a first finger-like electrode 4011b. The second electrode 4012 includes a second strip-like electrode 4012a and a second finger-like electrode 4012b. The first strip-like electrode 4011a and the second strip-like electrode 4012a extend along a first axial direction and are parallel. The first finger-like electrode 4011b extends from the first strip-like electrode 4011a towards the second strip-like electrode 4012a along a second axial direction. The second finger-like electrode 4012b extends from the second strip-like electrode 4012a towards the first strip-like electrode 4011a along the second axial direction. The first finger-like electrode 4011b and the second finger-like electrode 4012b are parallel and are alternately arranged, as shown in FIG. 3. The first axial direction is different from the second axial direction. In the embodiment, the first axial direction is perpendicular to the second axial direction. Further, the detecting electrode 401 may be made of at least one material selected from the group consisting of ITO, copper, nickel, chromium, iron, tungsten, phosphorous, cobalt and silver. The separating portion 402 includes a plurality of separating walls 4021 away from the insulation layer 30 and extending upwards. The separating walls 4021 surround the detecting electrode 401 to form an accommodating space 4022. The reaction sensing film 403 is in the accommodating space 4022 in the separating portion 402 and in contact with the detecting electrode 401. In practice, the reaction sensing film 403 comes into contact with a gas under test to produce an electrochemical reaction to cause the detecting electrode 401 to generate a recognition signal corresponding to the gas under test.

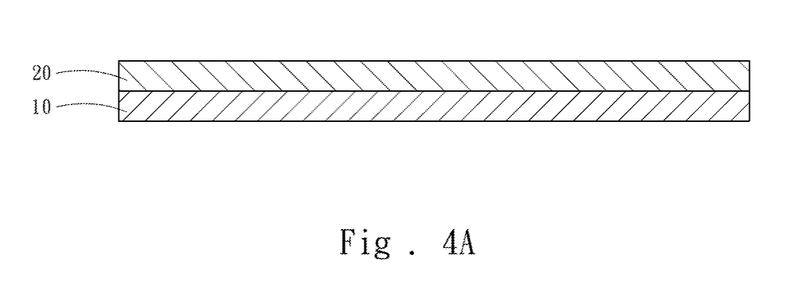

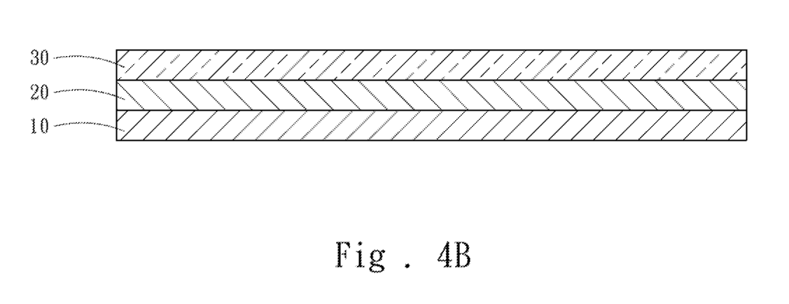

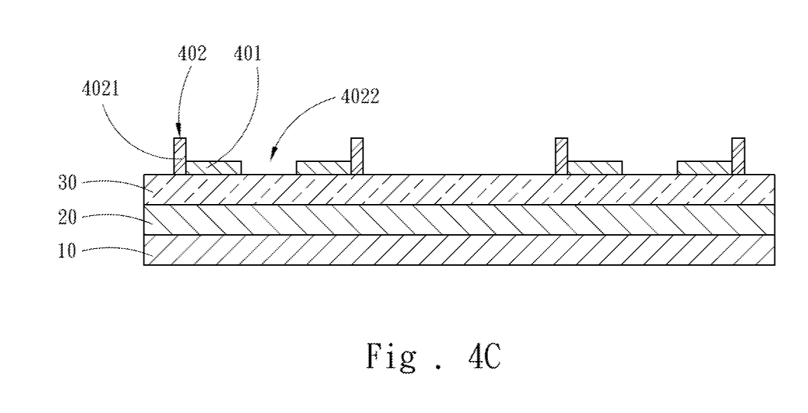

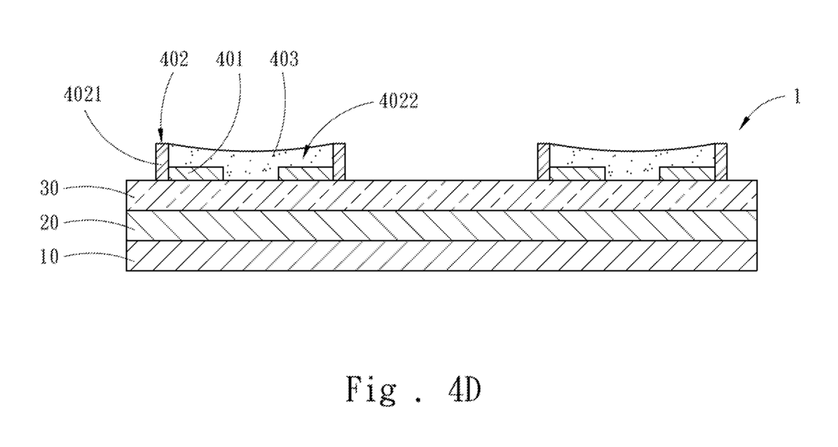

FIG. 4A to FIG. 4D show schematic diagrams of a process of a manufacturing method according to an embodiment of the present invention. The present invention further provides a manufacturing method of the gas sensor 1. Referring to FIG. 4A to FIG. 4D, the manufacturing method includes following steps.

As show in FIG. 4A, a substrate 10 is provided, and a heating layer 20 is formed on the substrate 10. The substrate 10 may be made of at least one material selected from the group consisting of glass, ITO and PET. The heating layer 20 receives a current to be heated to a temperature between 30° C. and 70° C., and may be made of ITO.

As shown in FIG. 4B, an insulation layer 30 is formed on the heating layer 20. The insulation layer 30 may be made of PET.

As shown in FIG. 4C, at least one detecting electrode 401 is formed on the insulation layer 30. The detecting electrode 401 includes a first electrode 4011 and a second electrode 4012. The first electrode 4011 includes a first strip-like electrode 4011a and a first finger-like electrode 4011b. The second electrode 4012 includes a second strip-like electrode 4012a and a second finger-like electrode 4012b. The first strip-like electrode 4011a and the second strip-like electrode 4012a extend along a first axial direction and are parallel. The first finger-like electrode 4011b extends from the first strip-like electrode 4011a towards the second strip-like electrode 4012a along a second axial direction. The second finger-like electrode 4012b extends from the second strip-like electrode 4012a towards the first strip-like electrode 4011a along the second axial direction. The first finger-like electrode 4011b and the second finger-like electrode 4012b are parallel and alternately arranged. The first axial direction is different from the second axial direction. In the embodiment, the first axial direction is perpendicular to the second axial direction. Further, the detecting electrode 401 may be made of at least one material selected from the group consisting of ITO, copper, nickel, chromium, iron, tungsten, phosphorous, cobalt and silver.

After the detecting electrode 401 is formed, a separating portion 402 is formed on the insulation layer 30. The separating portion 402 surrounds the detecting electrode 401, and includes a plurality of separating walls 4021 away from the insulation layer 30 and extending upwards. The separating walls 4021 surround the detecting electrode 401 to form an accommodating space 4022 on the detecting electrode 401.

As shown in FIG. 4D, a macromolecular material is filled in the accommodating space 4022 in the separating portion 402 and a reaction sensing film 403 is formed. The reaction sensing film 403 is in contact with the detecting electrode 401.

In conclusion, the gas sensor obtained by the method of the present invention is advantaged by having a simple structure. Further, the foregoing steps may be performed by a thick film process, e.g., roll-to-roll processing, without involving semiconductor fabrication processes or thin film technologies. Therefore, the present invention can be readily manufactured at lower costs, and is suitable for mass production.

What is claimed is:

1. A gas sensor, comprising:
a substrate;
a heating layer on the substrate;
an insulation layer on the heating layer; and
a plurality of detection units arranged on the insulation layer, each of the detection units comprising at least one detecting electrode, a separating portion surrounding the detecting electrode, and a reaction sensing film, the detecting electrode comprising a first electrode and a second electrode, the first electrode comprising a first strip-like electrode and a first finger-like electrode extending from the first strip-like electrode, the second electrode comprising a second strip-like electrode and a second finger-like electrode extending from the second strip-like electrode, the first finger-like electrode and the second finger-like electrode alternately arranged, the reaction sensing film in an accommodating space in the separating portion and in contact with the detecting electrode;
wherein, the reaction sensing film comes into contact with a gas under test to generate an electrochemical reaction to cause the detecting electrode to generate a recognition signal corresponding to the gas under test.

2. The gas sensor of claim 1, wherein the substrate is made of a material selected from the group consisting of glass, indium tin oxide (ITO) and polyethylene terephthalate (PET).

3. The gas sensor of claim 1, wherein the heating layer receives a current and is heated to a temperature between 30° C. and 70° C.

4. The gas sensor of claim 1, wherein the heating layer is made of indium tin oxide (ITO).

5. The gas sensor of claim 1, wherein the insulation layer is made of polyethylene terephthalate (PET).

6. The gas sensor of claim 1, wherein the detecting electrode is made of a material selected from the group consisting of indium tin oxide (ITO), copper, nickel, chromium, iron, tungsten, phosphorous, cobalt and silver.

7. The gas sensor of claim 1, wherein the separating portion comprises a plurality of separating walls away from the insulation layer and extending upwards, and the separating walls surround to form the accommodating space.

8. The gas sensor of claim 1, wherein the first strip-like electrode and the second strip-like electrode of the detecting electrode extend along a first axial direction and are parallel, the first finger-like electrode extends from the first strip-like electrode towards the second strip-like electrode along a second axial direction that different from the first axial direction, the second finger-like electrode extends from the second strip-like electrode towards the first strip-like electrode along the second axial direction, and the first finger-like electrode and the second finger-like electrode are parallel.

9. A manufacturing method of a gas sensor, comprising:
providing a substrate;
forming a heating layer on the substrate;
forming an insulation layer on the heating layer;
forming at least one detecting electrode on the insulation layer, the detecting electrode comprising a first electrode and a second electrode, the first electrode comprising a first strip-like electrode and a first finger-like electrode extending from the first strip-like electrode, the second electrode comprising a second strip-like electrode and a second finger-like electrode extending from the second strip-like electrode, the first finger-like electrode and the second finger-like electrode alternately arranged;
forming a separating portion on the insulation layer, the separating portion surrounding the detecting electrode, and forming an accommodating space on the detecting electrode; and
filling a macromolecular material into the accommodating space in the separating portion, and forming a reaction sensing film to obtain the gas sensor.

10. The manufacturing method of a gas sensor of claim 9, wherein the substrate is made of a material selected from the group consisting of glass, indium tin oxide (ITO) and polyethylene terephthalate (PET).

11. The manufacturing method of a gas sensor of claim 9, wherein the heating layer receives a current and is heated to a temperature between 30° C. and 70° C.

12. The manufacturing method of a gas sensor of claim 9, wherein the heating layer is made of indium tin oxide (ITO).

13. The manufacturing method of a gas sensor of claim 9, wherein the insulation layer is made of polyethylene terephthalate (PET).

14. The manufacturing method of a gas sensor of claim 9, wherein the detecting electrode is made of a material selected from the group consisting of indium tin oxide (ITO), copper, nickel, chromium, iron, tungsten, phosphorous, cobalt and silver.

15. The manufacturing method of a gas sensor of claim 9, wherein the separating portion comprises a plurality of separating walls away from the insulation layer and extending upwards, and the separating walls surround to form the accommodating space.

16. The manufacturing method of a gas sensor of claim 9, wherein the first strip-like electrode and the second strip-like electrode of the detecting electrode extend along a first axial direction and are parallel, the first finger-like electrode extends from the first strip-like electrode towards the second strip-like electrode along a second axial direction that is different from the first axial direction, the second finger-like electrode extends from the second strip-like electrode towards the first strip-like electrode along the second axial direction, and the first finger-like electrode and the second finger-like electrode are parallel.
